(19) United States
(12) Patent Application Publication
(10) Pub. No.: US 2007/0102930 A1
(43) Pub. Date: May 10, 2007

(54) Starting control apparatus

(75) Inventors: Masaki Koike, Hyogo (JP); Norio Tsuruta, Hyogo (JP); Takeshi Sakamoto, Hyogo (JP); Yasuo Ono, Hyogo (JP)

Correspondence Address: OLIFF & BERRIDGE, PLC, P.O. BOX 19928, ALEXANDRIA, VA, 22320, US

(73) Assignee: FUJITSU TEN LIMITED, KOBE-SHI (JP)

(21) Appl. No.: 11/585,955

(22) Filed: Oct. 25, 2006

(30) Foreign Application Priority Data
Oct. 28, 2005 (JP) 2005-314984

(51) Int. Cl. B60L 11/12

(52) U.S. Cl. 290/18

(57) ABSTRACT

A starting control apparatus includes a state determining unit that determines whether each of a plurality of power units is in any one of a normal state and an abnormal state, and a warming-up control unit that controls an abnormal power unit not to start and causes a normal power unit to start a power source and to carry out warming-up of the vehicle.

### CROSS-REFERENCE TO RELATED APPLICATIONS

The present document incorporates by reference the entire contents of Japanese priority document, 2005-314984 filed in Japan on Oct. 28, 2005.

### BACKGROUND OF THE INVENTION

1. Field of the Invention

The present invention generally relates to a starting control apparatus for performing starting control of a vehicle self-directively or based on a signal received from a remote control terminal. The present invention particularly relates to a starting control apparatus for a hybrid vehicle that includes a plurality of vehicle drive mechanisms.

2. Description of the Related Art

Recently, there has been a need to warm up a vehicle (including preparation for vehicle running) and/or to start the air-conditioner of the vehicle in advance. To respond to this need, starting control devices have been put into practical use by which it is possible to start the engine by remote control or at a predetermined time point by using a timer or the like (i.e., self-directively) while the driver is still outside the vehicle. For example, when receiving an engine-start request from a remote control terminal held by the driver (remote key), this starting control device executes operation similarly to when starting operation is performed with a key. Precisely, the starting control device activates a starter motor. As a result, an engine control device carries out fuel injection.

A state of a vehicle on which such starting control device is mounted changes in accordance with an environment in which the vehicle is standing. Therefore, when the starting control device activates the starter motor, it is desired to perform vehicle control appropriate to the state of the vehicle.

A remotely controlled engine starter disclosed in Japanese Patent Application Laid-open No. H9-21377 is a remotely controlled engine starter that starts the engine of a vehicle by remote control by using a radio wave or the like. When the water temperature of the engine exceeds a predetermined value, the remotely controlled engine starter controls a starting control device arranged on the vehicle not to start the engine even if receiving a starting signal from a remote device.

However, the conventional technologies have a problem that when a vehicle includes a plurality of vehicle drive mechanisms as power sources, starting control of the vehicle appropriate to respective states of the vehicle drive mechanisms cannot be performed.

### SUMMARY OF THE INVENTION

It is an object of the present invention to at least partially solve the above problems.

According to an aspect of the present invention, a starting control apparatus for a vehicle that includes a plurality of power units includes a state determining unit that determines whether each of the power units is in an abnormal state; and a warming-up control unit that controls power unit determined as in the abnormal state by the state determining unit to be kept to an inactive state, and causes power unit determined as not in the abnormal state by the determining unit to start a power source and to carry out warming-up.

The above and other objects, features, and advantages of this invention will be better understood by reading the following detailed description with reference to the accompanying drawings.

### BRIEF DESCRIPTION OF THE DRAWINGS

FIG. 1 is a schematic for explaining a concept of a vehicle control system according to a first embodiment.

FIG. 2 is a diagram of configuration of the vehicle control system according to the first embodiment.

FIG. 3 is a block diagram of configuration of a vehicle remote-control apparatus.

FIG. 4 is a flowchart of a process procedure performed by the vehicle control system according to the first embodiment during warming-up.

FIG. 5 is a sequence chart of a process procedure performed by the vehicle control system when a motor is in an abnormal state.

FIG. 6 is a sequence chart of a process procedure performed by the vehicle control system when an engine is in an abnormal state.

FIG. 7 is a sequence chart of a process procedure performed by the vehicle control system when performing starting control of the motor and the engine based on stored information.

### DETAILED DESCRIPTION OF THE PREFERRED EMBODIMENTS

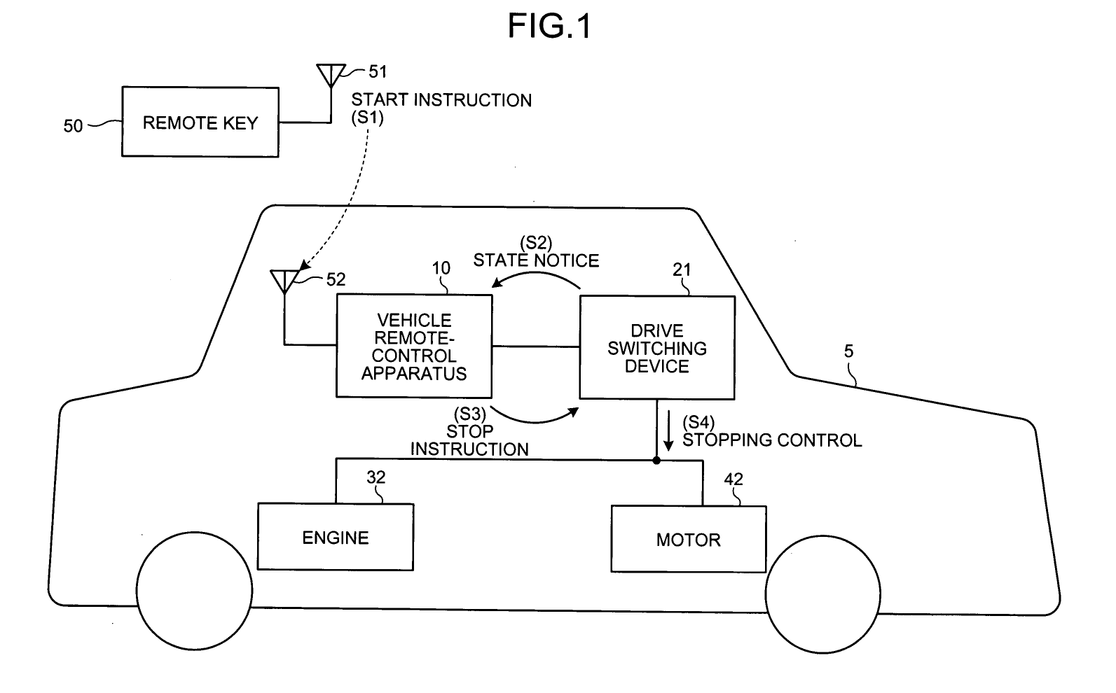

FIG. 1 is according to embodiments.

Exemplary embodiments of a starting control apparatus according to the present invention will be explained below in detail with reference to accompanying drawings. In the following description, after explaining an outline and features of a starting control apparatus according to the present invention, a starting control apparatus according to a first embodiment of the present invention is explained, and finally various modifications (second embodiment) will be explained as other embodiments.

Outline and Features

To begin with, an outline and features of a vehicle control system that includes a starting control apparatus (vehicle remote-control apparatus) according to the present invention are explained below. FIG. 1 is a schematic for explaining a concept of the vehicle control system according to the first embodiment. A vehicle 5 is a hybrid vehicle, and includes a plurality of types of vehicle drive mechanisms (vehicle drive units) (power sources). Explained below is a case where the vehicle 5 includes an engine 32 and a motor 42 as vehicle drive mechanisms.

In a vehicle control system 1, when a remote key 50 that remotely controls the vehicle 5 sends instruction information for warming up the vehicle 5 (instruction to start the engine 32 and the motor 42 (start instruction)) (S1), the vehicle 5 starts processing for warming up the vehicle 5. Here, the warming-up means not only typical operation of warming up the engine 32, but also includes a state of preparation for running (standby state in which a vehicle can run promptly in response to driver's operation) of a hybrid vehicle, a fuel cell powered vehicle, or an electric vehicle.

The vehicle 5 includes a vehicle remote-control apparatus 10 that stops or starts the engine 32 and the motor 42 in accordance with error states of the engine 32 and the motor 42. In addition, because the vehicle 5 is a hybrid vehicle, it includes a drive switching device 21 for starting and stopping (switching) the engine 32 and the motor 42.

When the engine 32 and the motor 42 start, the drive switching device 21 acquires state information whether the engine 32 and the motor 42 are in an error state, and sends the state information to the vehicle remote-control apparatus 10 (S2).

The vehicle remote-control apparatus 10 determines whether the engine 32 and/or the motor 42 is to be stopped (error or not) based on the state information acquired from the drive switching device 21. If the vehicle remote-control apparatus 10 determines to stop the engine 32 or the motor 42, the vehicle remote-control apparatus 10 sends instruction information for stopping the engine 32 or the motor 42 to the drive switching device 21 (S3).

If the engine 32 is in an abnormal state, for example, the vehicle remote-control apparatus 10 sends instruction information for stopping the engine 32 to the drive switching device 21. On the other hand, if the motor 42 is in an abnormal state, the vehicle remote-control apparatus 10 sends instruction information for stopping the motor 42 to the drive switching device 21.

When receiving the instruction information for stopping the engine 32 and/or the motor 42 from the vehicle remote-control apparatus 10, the drive switching device 21 stops the engine 32 and/or the motor 42. In other words, when the drive switching device 21 receives the instruction information for stopping the engine 32 from the vehicle remote-control apparatus 10, the drive switching device 21 stops the engine 32; while when the drive switching device 21 receives the instruction information for stopping the motor 42 from the vehicle remote-control apparatus 10, the drive switching device 21 stops the motor 42 (S4).

Thus, the vehicle remote-control apparatus 10 stops a vehicle drive mechanism (the engine 32 or the motor 42) that is in an abnormal state when performing the warming-up of the vehicle 5. Accordingly, the vehicle remote-control apparatus 10 can perform the warming-up of the vehicle 5 while reducing damage to the vehicle drive mechanism that is in the abnormal state.

### First Embodiment

Next, the vehicle control system that includes the vehicle remote-control apparatus (starting control apparatus) according to the first embodiment is explained below in detail. In the following, after explaining configuration of the vehicle control system 1 and the vehicle remote-control apparatus 10 according to the first embodiment, each of processing procedures performed by the vehicle remote-control apparatus 10 will be explained.

Configuration of Vehicle Control System

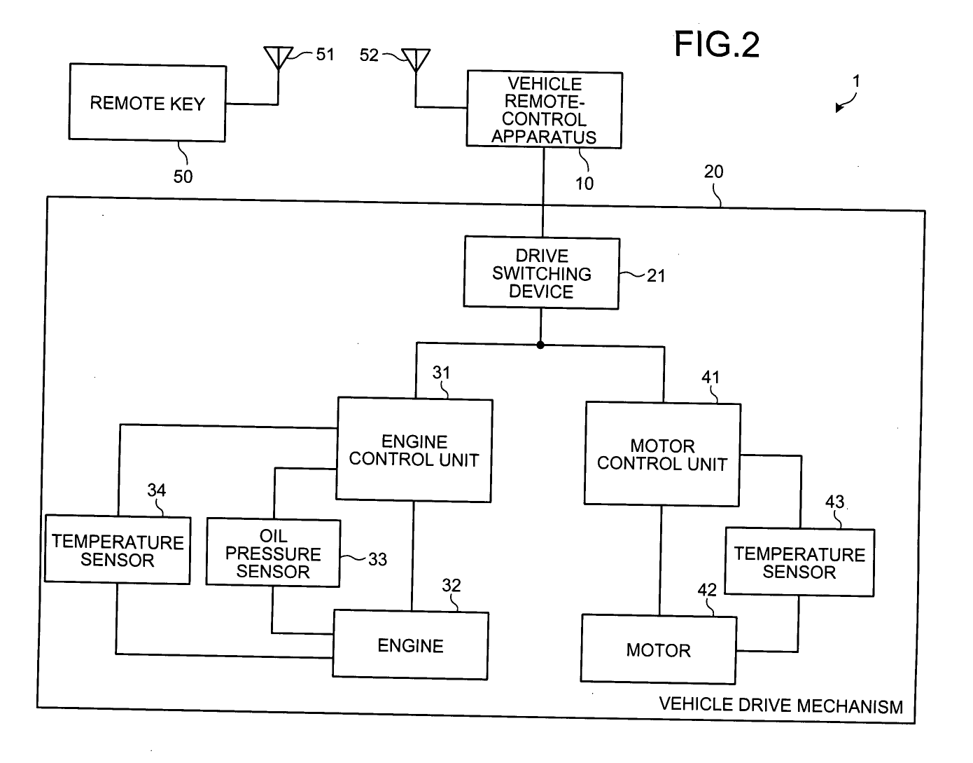

FIG. 2 is a diagram of the configuration of the vehicle control system 1 according to the first embodiment. The vehicle control system 1 includes a vehicle drive mechanism 20, the vehicle remote-control apparatus 10, and the remote key 50 that instructs the vehicle 5 to start.

The remote key 50 is a remote control terminal that a user holds, and sends a start request (start-instruction information) and a stop request (stop-instruction information) of the warming-up to the vehicle remote-control apparatus 10. The remote key 50 includes an antenna 51, via which the remote key 50 sends the start-instruction information and the stop-instruction information to the vehicle remote-control apparatus 10. The remote key 50 can also be configured to send a lock request and an unlock request for doors.

The vehicle remote-control apparatus (electrical control unit (ECU) for the remote engine starter (RES)) 10 includes an antenna 52, via which the vehicle remote-control apparatus 10 receives information (the start-instruction information and the stop-instruction information) sent from the remote key 50 by such as wireless transmission. The vehicle remote-control apparatus 10 is a starting control apparatus that performs the starting control of the vehicle 5 self-directively or based on information sent from the remote key 50 and information sent from the vehicle drive mechanism 20 (information about states of the engine 32 and the motor 42). The vehicle remote-control apparatus 10 sends certain instruction information to the vehicle drive mechanism 20, and controls the vehicle drive mechanism 20. For example, if the engine 32 is in an abnormal state (error state), the vehicle remote-control apparatus 10 sends the instruction information for stopping the engine 32 to the drive switching device 21. If the motor 42 is in an abnormal state, the vehicle remote-control apparatus 10 sends the instruction information for stopping the motor 42 to the drive switching device 21.

The vehicle drive mechanism 20 is installed on the vehicle 5, and connected to the vehicle remote-control apparatus 10. The vehicle drive mechanism 20 controls the warming-up of the vehicle 5, driving for running of the vehicle 5, and the like, based on information (instruction information) sent from the vehicle remote-control apparatus 10. In the first embodiment, when the vehicle drive mechanism 20 performs the warming-up (in a state of a gear in the parking position), the vehicle remote-control apparatus 10 instructs the vehicle drive mechanism 20 of certain control (starting control or stopping control). In this case, the vehicle drive mechanism 20 includes an engine control unit 31, the engine 32, an oil pressure sensor 33, a temperature sensor 34, a motor control unit 41, the motor 42, and a temperature sensor 43.

Based on the instruction information from the vehicle remote-control apparatus 10, the drive switching device 21 instructs the engine control unit 31 to perform the stopping control and the starting control over the engine 32, and also instructs the motor control unit 41 to perform the stopping control and the starting control over the motor 42. The drive switching device 21 acquires information about the states of the engine 32 and the motor 42 (hereinafter, state information), and sends the state information to the vehicle remote-control apparatus 10. In this case, the state information includes, for example, information about an error in the engine 32 (information indicating that the engine 32 is in an abnormal state), and information about an error in the motor 42.

The engine control unit (electronically-controlled fuel-injection device) (ECU for electronic fuel injection (EFI)) 31 is a control device that electronically controls operation of the engine 32. The engine control unit 31 controls the engine 32 (stopping control and starting control) based on the instruction information from the drive switching device 21. The engine control unit 31 determines whether the engine 32 has a temperature error based on a measured temperature of the engine 32 measured by the temperature sensor 34, and also determines whether the engine 32 has an oil pressure error based on an oil pressure value in the engine 32 measured by the oil pressure sensor 33.

The engine 32 performs the warming-up of the vehicle 5 and the driving for the running of the vehicle 5. The engine 32 according to the first embodiment is connected to an air-conditioner that is not shown in the drawings. If the engine 32 can performs normal operation, the engine 32 performs the warming-up of the vehicle 5 by driving the air-conditioner.

The oil pressure sensor 33 is connected to the engine 32, measures an oil pressure value in the engine 32, and inputs a result of measurement into the engine control unit 31. The temperature sensor 34 is connected to the engine 32, measures the temperature of the engine 32, and inputs a result of measurement into the engine control unit 31. The oil pressure sensor 33 and the temperature sensor 34 can be turned ON by driving the engine 32 when the engine 32 is in operation, or can be turned ON by driving the motor 42 when the motor 42 is in operation.

The motor control unit (ECU) 41 controls (stopping control and starting control) the motor 42 that performs the warming-up of the vehicle 5 and the driving for the running of the vehicle 5 based on the instruction information from the drive switching device 21. The motor control unit 41 determines whether the motor 42 has a temperature error based on a measured temperature of the motor 42 measured by the temperature sensor 43.

The motor 42 has a function of regenerating braking energy of the vehicle 5 and energy generated by driving the engine 32, and performs the warming-up of the vehicle 5 and the driving for the running of the vehicle 5. The motor 42 according to the first embodiment is connected to an air-conditioner that is not shown in the drawings. If the motor 42 can performs normal operation, the motor 42 performs the warming-up of the vehicle 5 by driving the air-conditioner.

The temperature sensor 43 is connected to the motor 42, measures the temperature of the motor 42, and inputs measured temperature into the motor control unit 41. The temperature sensor 43 can be turned ON by driving the engine 32 when the engine 32 is in operation, or can be turned ON by driving the motor 42 when the motor 42 is in operation.

Thus, the vehicle 5 according to the first embodiment is configured such that the warming-up and other operations of the vehicle 5 are instructed by the remote key 50, and on the vehicle 5 side, the warming-up and other operations of the vehicle 5 are performed based on an instruction from the remote key 50. Moreover, the vehicle 5 includes two vehicle drive mechanisms corresponding to the engine 32 and the motor 42, and is configured to switch drive control between the engine 32 and the motor 42 by the drive switching device 21.

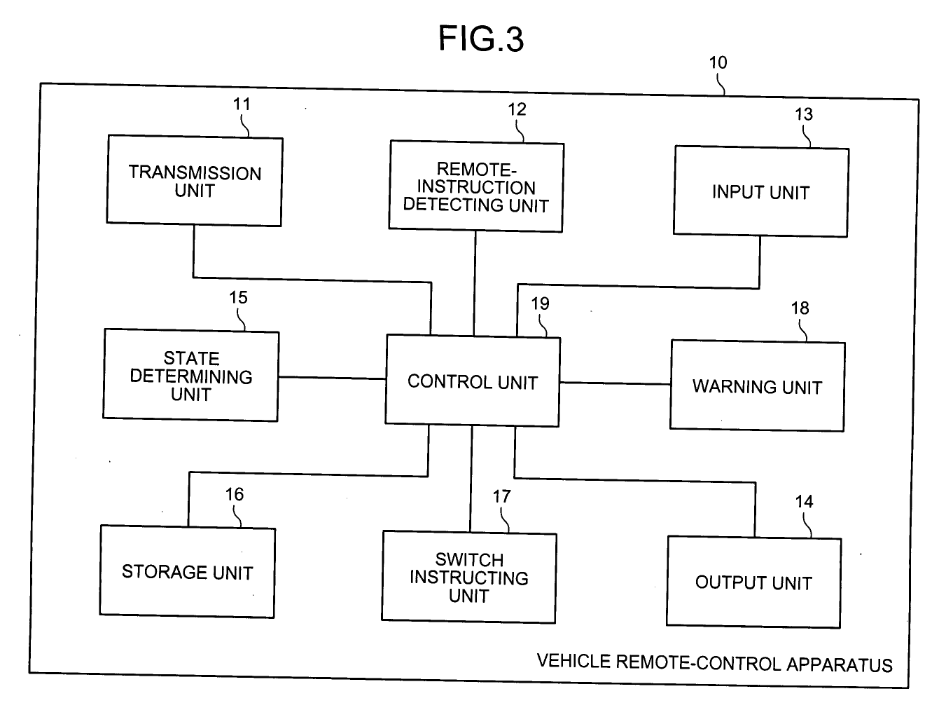

Next, configuration of the vehicle remote-control apparatus 10 is explained below. FIG. 3 is a block diagram of the configuration of the vehicle remote-control apparatus. The vehicle remote-control apparatus 10 includes a transmission unit 11, a remote-instruction detecting unit 12, an input unit 13, an output unit 14, a state determining unit 15, a storage unit 16, a switch instructing unit (warming-up control unit) 17, a warning unit 18, and a control unit 19.

The transmission unit 11 is connected to the antenna 52, and includes a remote key tuner. In this case, the transmission unit 11 receives information sent from the remote key 50 via the antenna 52, and sends received information to the remote-instruction detecting unit 12. In addition, when the warning unit 18 creates certain warning information, the transmission unit 11 sends the warning information to the remote key 50 via the antenna 52.

The remote-instruction detecting unit 12 extracts the start-instruction information for warming up the vehicle 5 from among information received by the transmission unit 11 from the remote key 50, and sends extracted information to the state determining unit 15. The input unit 13 is connected to the drive switching device 21, and receives information sent from the drive switching device 21 (state information of the engine 32 and the motor 42).

The state determining unit 15 determines whether the states of the engine 32 and the motor 42 are an abnormal state based on information received by the input unit 13 from the drive switching device 21, and sends a result of this determination to the switch instructing unit 17. In addition, when receiving the start-instruction information for the vehicle 5 sent from the remote key 50, the state determining unit 15 determines whether to permit starting control of the engine 32 and the motor 42 based on information present in the storage unit 16 (information whether the states of the engine 32 and the motor 42 are an abnormal state). The state determining unit 15 then sends a result of this determination to the switch instructing unit 17.

For example, if the state of the engine 32 is abnormal, the state determining unit 15 determines to set the engine 32 in a state where starting is inhibited. If the state of the motor 42 is abnormal, the state determining unit 15 determines to set starting of the motor 42 in a state where starting is inhibited. By contrast, if the state of the engine 32 is normal, the state determining unit 15 determines to set the engine 32 in a state where starting is permitted. If the state of the motor 42 is normal, the state determining unit 15 determines to set the motor 42 in a state where starting is permitted.

The state determining unit 15 causes the storage unit 16 to store therein the result of the determination obtained by the state determining unit 15 whether the motor 42 and/or the engine 32 are to be set in the state where the starting is inhibited. For example, if a result of determination that the engine 32 is to be set in the state where the starting is inhibited is present in the storage unit 16, the state determining unit 15 does not send an engine start-instruction information to the drive switching device 21 when receiving the start-instruction information from the remote key 50. In other words, if the state determining unit 15 determines to set the engine 32 in the state where the starting is inhibited, and causes the storage unit 16 to store therein the result of its determination, the vehicle remote-control apparatus 10 goes in a state not to receive an instruction to start the engine 32.

By contrast, if a result of determination that the engine 32 is to be set in the state where the starting is permitted is present in the storage unit 16, the state determining unit 15 sends the engine start-instruction information to the drive switching device 21 when receiving the start-instruction information from the remote key 50. In other words, if the state determining unit 15 determines to set the engine 32 in the state where the starting is permitted, and causes the storage unit 16 to store therein the result of its determination, the vehicle remote-control apparatus 10 goes in a state to receive an instruction to start the engine 32.

In addition, if a result of determination that the motor 42 is to be set in the state where the starting is inhibited is present in the storage unit 16, the state determining unit 15 does not send a motor start-instruction information to the drive switching device 21 when receiving the start-instruction information from the remote key 50. In other words, if the state determining unit 15 determines to set the motor 42 in the state where the starting is inhibited, and causes the storage unit 16 to store therein the result of its determination, the vehicle remote-control apparatus 10 goes in a state not to receive an instruction to start the motor 42.

By contrast, if a result of determination that the motor 42 is to be set in the state where the starting is permitted is present in the storage unit 16, the state determining unit 15 sends the motor start-instruction information to the drive switching device 21 when receiving the start-instruction information from the remote key 50. In other words, if the state determining unit 15 determines to set the motor 42 in the state where the starting is permitted, and causes the storage unit 16 to store therein the result of its determination, the vehicle remote-control apparatus 10 goes in a state to receive an instruction to start the motor 42.

Based on results of determination sent from the state determining unit 15 (result of the determination whether the states of the engine 32 and the motor 42 are an abnormal state, and result of the determination whether the engine 32 and the motor 42 are to be set in the state where the starting is inhibited), the switch instructing unit 17 creates an engine stop-instruction information to control and stop the engine 32, the engine staring instruction information to start the engine 32, a motor stop-instruction information to control and stop the motor 42, and the motor start-instruction information to start the motor 42. The switch instructing unit 17 sends these created information to the vehicle drive mechanism 20 via the output unit 14, and controls the drive switching device 21.

The storage unit 16 stores therein results of determination obtained by the state determining unit 15, for example, a result of the determination whether the states of the engine 32 and the motor 42 are an abnormal state, and a result of the determination whether the engine 32 and the motor 42 are to be set in the state where the starting is inhibited.

The warning unit 18 outputs warning information that indicates an error in the engine 32 and/or an error in the motor 42 based on results of determination obtained by the state determining unit 15. The warning information is sent to the remote key 50 via the antenna 52. The warning information can be audio, text, or a lighting instruction with a warning lamp (not shown) that the remote key 50 includes.

The output unit 14 is connected to the drive switching device 21, and sends instruction information created by the switch instructing unit 17 (the engine stop-instruction information, the engine start-instruction information, the motor stop-instruction information, and the motor start-instruction information) to the drive switching device 21. The control unit 19 controls the transmission unit 11, the remote-instruction detecting unit 12, the input unit 13, the output unit 14, the state determining unit 15, the storage unit 16, the switch instructing unit 17, and the warning unit 18.

Procedure of Processing

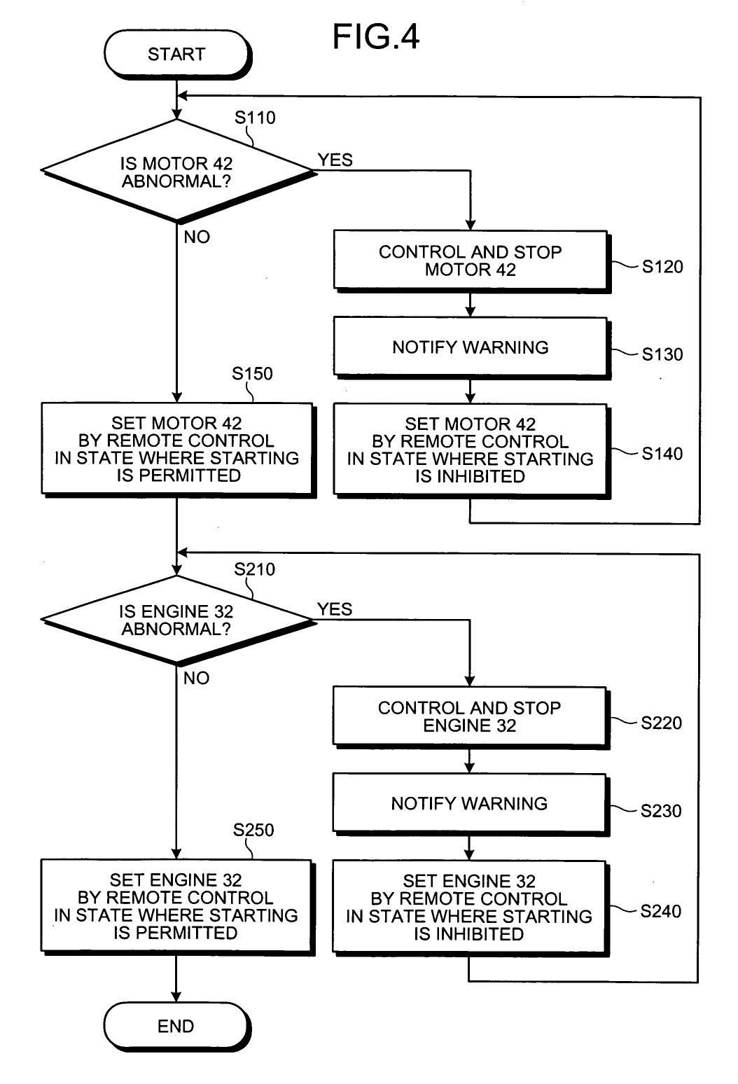

Next, each of the processing procedures performed by the vehicle control system 1 according to the first embodiment will be explained below. First, a processing procedure performed by the vehicle control system 1 when the engine 32 and the motor 42 are in operation is explained below. FIG. 4 is a flowchart of an operation procedure performed by the vehicle control system according to the first embodiment when the engine 32 and the motor 42 are in operation (during the warming-up).

In response to the start-instruction information from the remote key 50, or an operation by a not-shown key, the motor 42 starts, and then the engine 32 starts. As a result, the warming-up of the vehicle 5 is started. When the motor 42 and the engine 32 start, the temperature sensor 43 starts to measure the temperature of the motor 42, and sends information about the temperature of the motor 42 to the motor control unit 41. The motor control unit 41 then starts to determine whether the motor 42 has a temperature error. This result of determination whether the motor 42 has the temperature error (state information) is sent to the vehicle remote-control apparatus 10 via the drive switching device 21 at a predetermined timing.

Moreover, when the engine 32 and the motor 42 start, the temperature sensor 34 starts to measure the temperature of the engine 32, while the oil pressure sensor 33 starts to measure the oil pressure in the engine 32. The temperature sensor 34 and the oil pressure sensor 33 send information about the temperature and the oil pressure of the engine 32 to the engine control unit 31. The engine control unit 31 then starts to determine whether the engine 32 has a temperature error and whether the engine 32 has an oil pressure error.

A result of determination whether the engine 32 has the temperature error (state information), and a result of determination whether the engine 32 has the oil pressure error are sent to the vehicle remote-control apparatus 10 via the drive switching device 21 at a predetermined timing.

The vehicle remote-control apparatus 10 inputs information sent from the drive switching device 21 (result of determination) with the input unit 13, and sends input information to the state determining unit 15. Based on information sent from the drive switching device 21, the state determining unit 15 determines whether the states of the engine 32 and the motor 42 are an abnormal state.

To begin with, based on the information sent from the drive switching device 21 at the predetermined timing, the state determining unit 15 determines whether the state of the motor 42 is an abnormal state (step S110). If the state determining unit 15 determines that the state of the motor 42 is the abnormal state (Yes at step S110), the state determining unit 15 sends a result of this determination to the switch instructing unit 17. The switch instructing unit 17 creates the motor stop-instruction information to control and stop the motor 42, and sends created information to the drive switching device 21 via the output unit 14. Consequently, the drive switching device 21 instructs the motor control unit 41 to stop the motor 42 (step S120). In other words, in the first embodiment, the vehicle remote-control apparatus 10 sends an instruction whether to stop the motor 42 to the vehicle drive mechanism 20 based on whether the state of the motor 42 is an abnormal state.

Furthermore, even if the drive switching device 21 instructs the motor control unit 41 to stop the motor 42, when the engine 32 is being driven, the temperature sensor 43 is kept ON by driving the engine 32. This allows the vehicle remote-control apparatus 10 (the motor control unit 41) to determine whether the motor 42 is in an abnormal state even when the motor 42 is inactive.

If the state of the motor 42 is an abnormal state, the warning unit 18 creates warning information indicating that the motor 42 is in the abnormal state. The warning unit 18 sends the warning information created by the warning unit 18 from the transmission unit 11 via the antenna 52 to the remote key 50. As a result, the user of the remote key 50 is notified of the warning information indicating an error in the motor 42 (step S130).

If determining that the state of the motor 42 is the abnormal state, the state determining unit 15 determines to set the motor 42 in the state where the starting is inhibited, and causes the storage unit 16 to store therein a result of this determination. After that, the state determining unit 15 determines whether to permit the starting control of the motor 42 based on information present in the storage unit 16 (the result of determination indicating that the state of the motor 42 is the abnormal state). Therefore, even if the state determining unit 15 receives the start-instruction information from the remote key 50 in the following processing, the state determining unit 15 instructs the switch instructing unit 17 not to send the motor start-instruction information to the drive switching device 21. In other words, the vehicle remote-control apparatus 10 goes in a state not to receive an instruction to start the motor 42 (state where the starting of the motor 42 by remote control is inhibited) (step S140).

After that, if the motor 42 is in an abnormal state, processing from steps S110 to S140 is repeated. Moreover, if the motor 42 has already been stopped, the processing at step S120 is not performed. Warning information is reported to the remote key 50 at a predetermined timing as required, and the state where the starting of the motor 42 by remote control is inhibited is continued.

By contrast, if determining that the state of the motor 42 is a normal state (No at step S110), the state determining unit 15 determines to set the motor 42 in the state where the starting is permitted, and causes the storage unit 16 to store therein a result of this determination. After that, the state determining unit 15 determines whether to permit the starting of the motor 42 based on information present in the storage unit 16 (the result of determination indicating that the state of the motor 42 is not the abnormal state). Therefore, if the state determining unit 15 receives the start-instruction information from the remote key 50 in the following processing (when the motor 42 is inactive), the state determining unit 15 instructs the switch instructing unit 17 to send the motor start-instruction information to the drive switching device 21. In other words, the vehicle remote-control apparatus 10 goes into a state to receive an instruction to start the motor 42 (state where the starting of the motor 42 by remote control is permitted) (step S150). After that, when the motor 42 is inactive, if receiving the motor start-instruction information from the switch instructing unit 17, the drive switching device 21 instructs the motor control unit 41 to start the motor 42.

Next, the state determining unit 15 determines whether the state of the engine 32 is an abnormal state based on information sent from the drive switching device 21 at a predetermined timing (step S210).

If the state determining unit 15 determines that the state of the engine 32 is the abnormal state (Yes at step S210), the state determining unit 15 sends a result of this determination to the switch instructing unit 17. The switch instructing unit 17 creates the engine stop-instruction information to control and stop the engine 32, and sends created information to the drive switching device 21 via the output unit 14. Consequently, the drive switching device 21 instructs the engine control unit 31 to stop the engine 32 (step S220). In other words, in the first embodiment, the vehicle remote-control apparatus 10 sends an instruction whether to stop the engine 32 to the vehicle drive mechanism 20 based on whether the state of the engine 32 is an abnormal state.

Furthermore, even if the drive switching device 21 instructs the engine control unit 31 to stop the engine 32, when the motor 42 is being driven, the temperature sensor 34 and the oil pressure sensor 33 are kept ON by driving the motor 42. This allows the vehicle remote-control apparatus 10 (the engine control unit 31) to determine whether the engine 32 is in an abnormal state even when the engine 32 is inactive.

If the state of the engine 32 is an abnormal state, the warning unit 18 creates warning information indicating that the engine 32 is in the abnormal state. The warning unit 18 sends the warning information created by the warning unit 18 from the transmission unit 11 via the antenna 52 to the remote key 50. As a result, the user of the remote key 50 is notified of the warning information indicating an error in the engine 32 (step S230).

When determining that the state of the engine 32 is the abnormal state, the state determining unit 15 determines to set the engine 32 in the state where the starting is inhibited, and causes the storage unit 16 to store therein a result of this determination. After that, the state determining unit 15 determines whether to permit the starting control of the engine 32 based on information present in the storage unit 16 (the result of determination indicating that the state of the engine 32 is the abnormal state). Therefore, even if the state determining unit 15 receives the start-instruction information from the remote key 50 in the following processing, the state determining unit 15 instructs the switch instructing unit 17 not to send the engine start-instruction information to the drive switching device 21. In other words, the vehicle remote-control apparatus 10 goes in a state not to receive an instruction to start the engine 32 (state where the starting of the engine 32 by remote control is inhibited) (step S240).

After that, if the engine 32 is in an abnormal state, processing from steps S210 to S240 is repeated. Moreover, if the engine 32 has already been stopped, the processing at step S210 is not performed. Warning information is reported to the remote key 50 at a predetermined timing as required, and the state where the starting of the engine 32 by remote control is inhibited is continued.

By contrast, if the state of the engine 32 is a normal state (No at step S210), the state determining unit 15 determines to set the engine 32 in the state where the starting is permitted, and causes the storage unit 16 to store therein a result of this determination. After that, the state determining unit 15 determines whether to permit the starting of the engine 32 based on information present in the storage unit 16 (the result of determination indicating that the state of the engine 32 is not the abnormal state). Therefore, if the state determining unit 15 receives the start-instruction information from the remote key 50 in the following processing (when the engine 32 is inactive), the state determining unit 15 instructs the switch instructing unit 17 to send the engine start-instruction information to the drive switching device 21. In other words, the vehicle remote-control apparatus 10 goes in a state to receive an instruction to start the engine 32 (state where the starting of the engine 32 by remote control is permitted) (step S250).

After that, when the engine 32 is inactive, if receiving the engine start-instruction information from the switch instructing unit 17, the drive switching device 21 instructs the engine control unit 31 to start the engine 32. The processing from steps S110 to S250 is repeated at a predetermined timing while performing the warming-up of the vehicle 5.

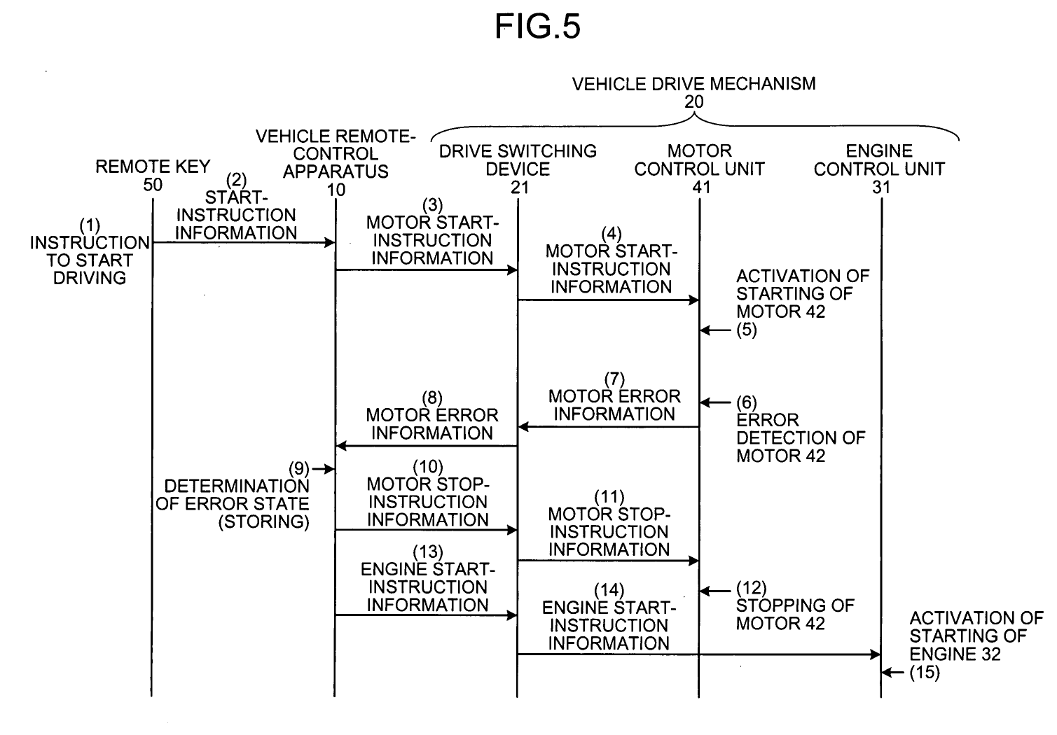

Next, processing procedures performed by the vehicle control system 1 when instructing the engine 32 or the motor 42 to start (a stopping control procedure for the motor 42, and a stopping control procedure for the engine 32) will be explained below. First, a processing procedure performed by the vehicle control system 1 if the motor 42 is in an abnormal state is explained below. FIG. 5 is a sequence chart of the processing procedure performed by the vehicle control system 1 when the motor 42 is in an abnormal state.

When the user inputs a request to perform the warming-up of the vehicle 5 (instruction to start driving of the vehicle 5) to the remote key 50 (1), a start request for the warming-up (information including the start-instruction information) is sent from the remote key 50 to the vehicle remote-control apparatus 10 (2).

The transmission unit 11 of the vehicle remote-control apparatus 10 receives the start request sent from the remote key 50 via the antenna 52. The transmission unit 11 then inputs the start request into the remote-instruction detecting unit 12. The remote-instruction detecting unit 12 extracts the start-instruction information from the start request, and inputs the extracted information into the state determining unit 15.

At this moment, the motor 42 and the engine 32 have not started, so that the temperature sensor 43 has not been actuated. For this reason, the vehicle remote-control apparatus 10 cannot determine whether the motor 42 is in an abnormal state. Therefore, the state determining unit 15 of the vehicle remote-control apparatus 10 instructs the switch instructing unit 17 to send the motor start-instruction information to the drive switching device 21 to start the motor 42 (3).

The drive switching device 21 sends the motor start-instruction information to the motor control unit 41 (4), and instructs the motor control unit 41 to start the motor 42. The motor 42 activates the starting (5), and the temperature sensor 43 starts to measure the temperature of the motor 42.

The temperature sensor 43 sends information about the temperature of the motor 42 (measured temperature) to the motor control unit 41. The motor control unit 41 determines whether the motor 42 has a temperature error based on the information from the temperature sensor 43.

If the motor 42 has the temperature error, the motor control unit 41 determines that the motor 42 is in an abnormal state (error detection of the motor 42) (6). When determining that the motor 42 is in the abnormal state, the motor control unit 41 sends state information indicating that the motor 42 is in the abnormal state (motor error information) to the drive switching device 21 (7).

The drive switching device 21 sends the motor error information received from the motor control unit 41 to the vehicle remote-control apparatus 10 (8). The state determining unit 15 of the vehicle remote-control apparatus 10 determines whether the motor 42 and the engine 32 are in an error state based on information received from the drive switching device 21. In this case, because the vehicle remote-control apparatus 10 receives the motor error information from the drive switching device 21, the state determining unit 15 determines that the motor 42 is in the abnormal state (9).

When determining that the state of the motor 42 is the abnormal state, the state determining unit 15 determines to set the motor 42 in the state where the starting is inhibited, and causes the storage unit 16 to store therein a result of this determination. As a result, the vehicle remote-control apparatus 10 goes in a state not to receive an instruction to start the motor 42 (state where the starting of the engine 32 by remote control is inhibited).

If the state of the motor 42 is an abnormal state, the warning unit 18 creates warning information indicating that the motor 42 is in the abnormal state, and sends created warning information from the transmission unit 11 via the antenna 52 to the remote key 50.

By contrast, if the state of the motor 42 is the normal state, the motor control unit 41 does not determine that the motor 42 is in an abnormal state (error), so that the motor error information is not sent from the motor control unit 41 via the drive switching device 21 to the vehicle remote-control apparatus 10. For this reason, if receiving no motor error information from the drive switching device 21, or if receiving the state information indicating that the motor 42 is in the normal state, the state determining unit 15 determines that the motor 42 is in the normal state.

The state determining unit 15 instructs the switch instructing unit 17 to create instruction information for stopping the motor 42 (the motor stop-instruction information), and to send created motor stop-instruction information to the drive switching device 21 via the output unit 14 (10). The drive switching device 21 sends the motor stop-instruction information from the vehicle remote-control apparatus 10 to the motor control unit 41 (11), and instructs the motor control unit 41 to stop the motor 42 (12).

After that, regardless of whether the motor 42 is in an abnormal state, the state determining unit 15 of the vehicle remote-control apparatus 10 instructs the switch instructing unit 17 to create instruction information for starting the engine 32 (the engine start-instruction information) at a predetermined timing, and to send created instruction information to the drive switching device 21 via the output unit 14 (13).

The drive switching device 21 sends the engine start-instruction information from the vehicle remote-control apparatus 10 to the engine control unit 31 (14), and instructs the engine control unit 31 to start the engine 32 (15). The engine 32 then performs the warming-up of the vehicle 5.

As a result, when performing the warming-up of the vehicle 5, can stop the motor 42 in the abnormal state, and start the engine 32 in the normal state, to perform the warming-up. Accordingly, can perform the warming-up of the vehicle 5 while reducing damage to the motor 42 in the abnormal state.

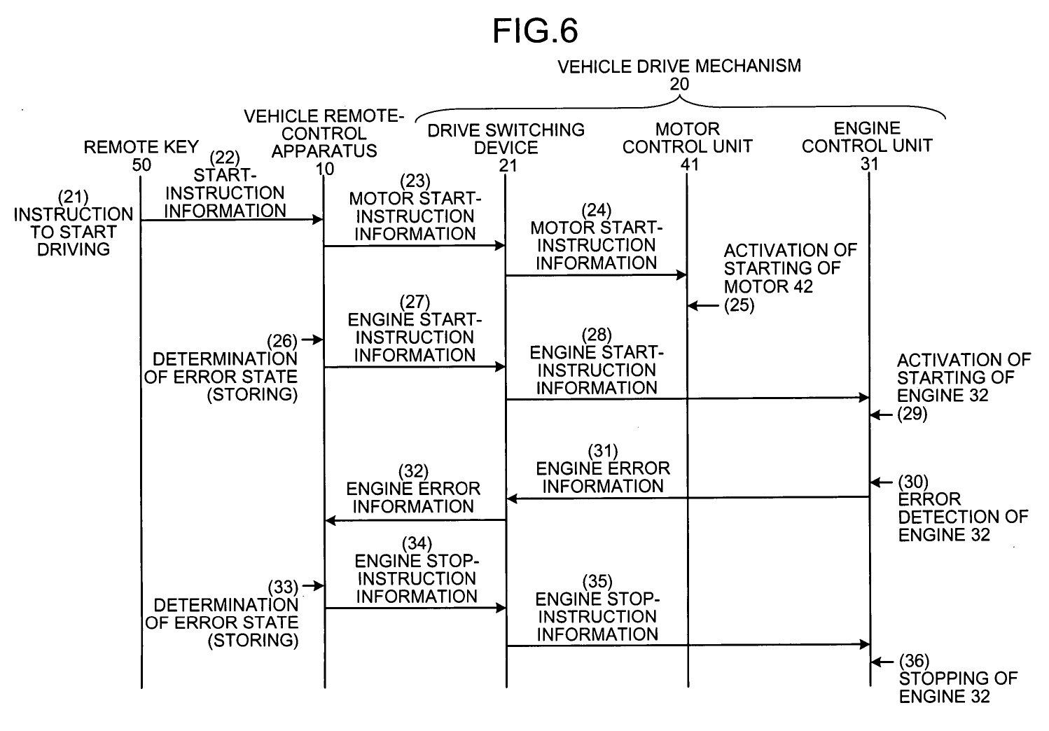

Next, a processing procedure performed by the vehicle control system 1 if the engine 32 is in an abnormal state is explained below. FIG. 6 is a sequence chart of the processing procedure performed by the vehicle control system 1 when the engine 32 is in an abnormal state.

When the user inputs a request to perform the warming-up of the vehicle 5 (instruction to start driving of the vehicle 5) to the remote key 50 (21), a start request for the warming-up (information including the start-instruction information) is sent from the remote key 50 (22).

The transmission unit 11 of the vehicle remote-control apparatus 10 receives the start request sent from the remote key 50 via the antenna 52. The transmission unit 11 then inputs the start request into the remote-instruction detecting unit 12. The remote-instruction detecting unit 12 then extracts the start-instruction information from the start request, and inputs extracted information into the state determining unit 15.

At this moment, the motor 42 and the engine 32 have not started, so that the temperature sensor 43 has not been started. For this reason, the vehicle remote-control apparatus 10 cannot determine whether the motor 42 is in an abnormal state. Therefore, the state determining unit 15 of the vehicle remote-control apparatus 10 instructs the switch instructing unit 17 to send the motor start-instruction information to the drive switching device 21 to start the motor 42 (23).

The drive switching device 21 sends the motor start-instruction information to the motor control unit 41 (24), and instructs the motor control unit 41 to start the motor 42. The motor 42 activates the starting (25), and the engine 32 performs the warming-up of the vehicle 5. At this moment, the temperature sensor 43 starts to measure the temperature of the motor 42.

The temperature sensor 43 sends information about the temperature of the motor 42 to the motor control unit 41. The motor control unit 41 determines whether the motor 42 has a temperature error based on the information from the temperature sensor 43.

If the motor 42 does not have the temperature error, the motor control unit 41 determines that the motor 42 is in the normal state. When determining that the motor 42 is in the normal state, the motor control unit 41 sends state information indicating that the motor 42 is in the normal state to the drive switching device 21, or sends no information to the drive switching device 21.

The state determining unit 15 determines whether the motor 42 is in an error state at a predetermined timing. If receiving no motor error information from the drive switching device 21 for a predetermined time period, or if receiving the state information indicating that the motor 42 is in the normal state, the state determining unit 15 determines that the motor 42 is in the normal state. In this case, because the vehicle remote-control apparatus 10 does not receive any information (such as the motor error information) from the drive switching device 21, the state determining unit 15 determines that the motor 42 is in the normal state (26).

Next, regardless of whether the motor 42 is in an abnormal state, the state determining unit 15 of the vehicle remote-control apparatus 10 instructs the switch instructing unit 17 to create instruction information for starting the engine 32 (the engine start-instruction information) at a predetermined timing, and to send created instruction information to the drive switching device 21 via the output unit 14 (27). The drive switching device 21 sends the engine start-instruction information from the vehicle remote-control apparatus 10 to the engine control unit 31 (28), and instructs the engine control unit 31 to start the engine 32.

The engine 32 activates the starting (29), and the temperature sensor 34 starts to measure the temperature of the engine 32, and the oil pressure sensor 33 starts to measure the oil pressure of the engine 32. The temperature sensor 34 sends information about the temperature of the engine 32 to the motor control unit 41, and the oil pressure sensor 33 sends information about the oil pressure of the engine 32 (oil pressure value) to the motor control unit 41. The engine control unit 31 determines whether the engine 32 has a temperature error based on the information from the temperature sensor 34. Moreover, the engine control unit 31 determines whether the engine 32 has an oil pressure error based on the information from the oil pressure sensor 33.

If the engine 32 has the temperature error, or the engine 32 has the oil pressure error, the engine control unit 31 determines that the engine 32 is in an abnormal state (error detection of the engine 32) (30). When determining that the engine 32 is in the abnormal state, the engine control unit 31 sends state information indicating that the engine 32 is in the abnormal state (engine error information) to the drive switching device 21 (31).

The drive switching device 21 sends the motor error information received from the engine control unit 31 to the vehicle remote-control apparatus 10 (32). The state determining unit 15 of the vehicle remote-control apparatus 10 determines whether the motor 42 and the engine 32 are in an error state based on information received from the drive switching device 21. In this case, because the vehicle remote-control apparatus 10 receives the engine error information from the drive switching device 21, the state determining unit 15 determines that the engine 32 is in the abnormal state (33).

When determining that the state of the engine 32 is the abnormal state, the state determining unit 15 determines to set the engine 32 in the state where the starting is inhibited, and causes the storage unit 16 to store therein a result of this determination. As a result, the vehicle remote-control apparatus 10 goes in a state not to receive an instruction to start the engine 32 (state where the starting of the engine 32 by remote control is inhibited).

If the state of the engine 32 is an abnormal state, the warning unit 18 creates warning information indicating that the engine 32 is in the abnormal state, and sends created warning information from the transmission unit 11 via the antenna 52 to the remote key 50.

The state determining unit 15 instructs the switch instructing unit 17 to create instruction information for stopping the engine 32 (the engine stop-instruction information), and to send created engine stop-instruction information to the drive switching device 21 via the output unit 14 (34). The drive switching device 21 sends the engine stop-instruction information from the vehicle remote-control apparatus 10 to the engine control unit 31 (35), and instructs the engine control unit 31 to stop the engine 32 (36).

As a result, when performing the warming-up of the vehicle 5, can stop the engine 32 in the abnormal state, and start the motor 42 in the normal state, to perform the warming-up. Accordingly, can perform the warming-up of the vehicle 5 while reducing damage to the engine 32 in the abnormal state.

In the first embodiment, the motor 42 or the engine 32 that is in an abnormal state is to be controlled and stopped. However, if either the motor 42 or the engine 32 is in an abnormal state, both the motor 42 and the engine 32 can be controlled and stopped to stop the vehicle drive mechanism 20. This produces the effect of avoiding damage of peripheral devices including the motor 42 and the engine 32, even if a peripheral device around the motor 42 and the engine 32 is in an abnormal state. If both the motor 42 and the engine 32 are in an abnormal state, both the motor 42 and the engine 32 are stopped, so that the warming-up of the vehicle 5 is not performed.

Moreover, it can be configured such that, if the motor 42 is in the normal state, the engine control unit 31, the oil pressure sensor 33, and the temperature sensor 34 are to be turned ON by driving the motor 42, and the engine control unit 31 is to determine whether the engine 32 is in an abnormal state. In this case, after the motor 42 starts, the vehicle remote-control apparatus 10 waits state information sent from the engine control unit 31. The vehicle remote-control apparatus 10 then sends either the engine stopping information or the engine starting information to the engine control unit 31 based on state information from the engine control unit 31.

In the first embodiment, explained is a case where the vehicle 5 includes vehicle drive mechanisms of the engine 32 and the motor 42. However, the vehicle 5 can be configured to include other vehicle drive mechanisms. Moreover, a hybrid vehicle can employ a series hybrid system, by which the engine 32 only generates electric power and only the motor 42 turns wheels, or a parallel hybrid system, by which both the engine 32 and the motor 42 turns wheels. Furthermore, a hybrid vehicle can employ a series-parallel hybrid system, which is a combination of the series system and the parallel system.

In the first embodiment, the vehicle drive mechanism 20 is configured to include the temperature sensor 34 and the oil pressure sensor 33, and to detect a temperature error and an oil pressure error in the engine 32 using the temperature sensor 34 and the oil pressure sensor 33. However, the vehicle drive mechanism 20 can be configured to include another sensor that detects an error in the engine 32 other than the temperature error and the oil pressure error. Moreover, the vehicle drive mechanism 20 is configured to include the temperature sensor 43, and detects a temperature error in the motor 42 using the temperature sensor 43. However, the vehicle drive mechanism 20 can be configured to include another sensor that detects an error in the motor 42 other than the temperature error.

For example, the vehicle drive mechanism 20 can be configured to include a sensor that detects revolutions of the motor 42 and/or the engine 32, and to detect a revolution error of the motor 42 and/or the engine 32 using this sensor. Moreover, the vehicle drive mechanism 20 can be configured to include a sensor that detects a locked state of the motor 42, and to detect a lock error of the motor 42 using this sensor.

Thus, according to the first embodiment, the vehicle remote-control apparatus 10 stops the motor 42 and/or the engine 32 in which an abnormal state is detected during the warming-up, thereby enabling the vehicle remote-control apparatus 10 to reduce damage to the motor 42 and/or the engine 32 in which an abnormal state is detected.

Moreover, inhibits the starting control of the motor 42 and/or the engine 32 in which an abnormal state is detected, thereby enabling to reduce damage to the motor 42 and/or the engine 32 in which an abnormal state is detected.

Furthermore, because determines whether the engine 32 and the motor 42 are in an abnormal state when starting the warming-up of the vehicle 5, and sends the stop-instruction information only to the engine 32 and/or the motor 42 that is in the abnormal state, if the engine 32 and/or the motor 42 is in the abnormal state, can stop only the engine 32 and/or the motor 42 that is in the abnormal state, thereby allowing the engine 32 and/or the motor 42 that is in the normal state to perform the warming-up. Accordingly, can perform the warming-up by efficiently driving the engine 32 and the motor 42 while reducing damage to the engine 32 and the motor 42.

### Second Embodiment

The first embodiment of the present invention has been explained above. The present invention can be implemented in various different embodiments other than the embodiments described above within a scope of technical principles described in appended claims.

Determination of State of Motor and Engine Based on Saved State Information Present in Storage

In the first embodiment, the vehicle remote-control apparatus 10 determines whether the motor 42 and the engine 32 are in an abnormal state based on the information from the vehicle drive mechanism 20 when starting the warming-up of the vehicle 5. However, the vehicle remote-control apparatus 10 can also determine whether the motor 42 and the engine 32 are in an abnormal state based on the information present in the storage unit 16 when starting the warming-up of the vehicle 5.

In this case, after the warming-up by the motor 42 and/or the engine 32 is finished, the information about the error in the motor 42 and the engine 32 present in the storage unit 16 is saved without deleting, to use saved information on the next occasion when performing the warming-up by the motor 42 and/or the engine 32.

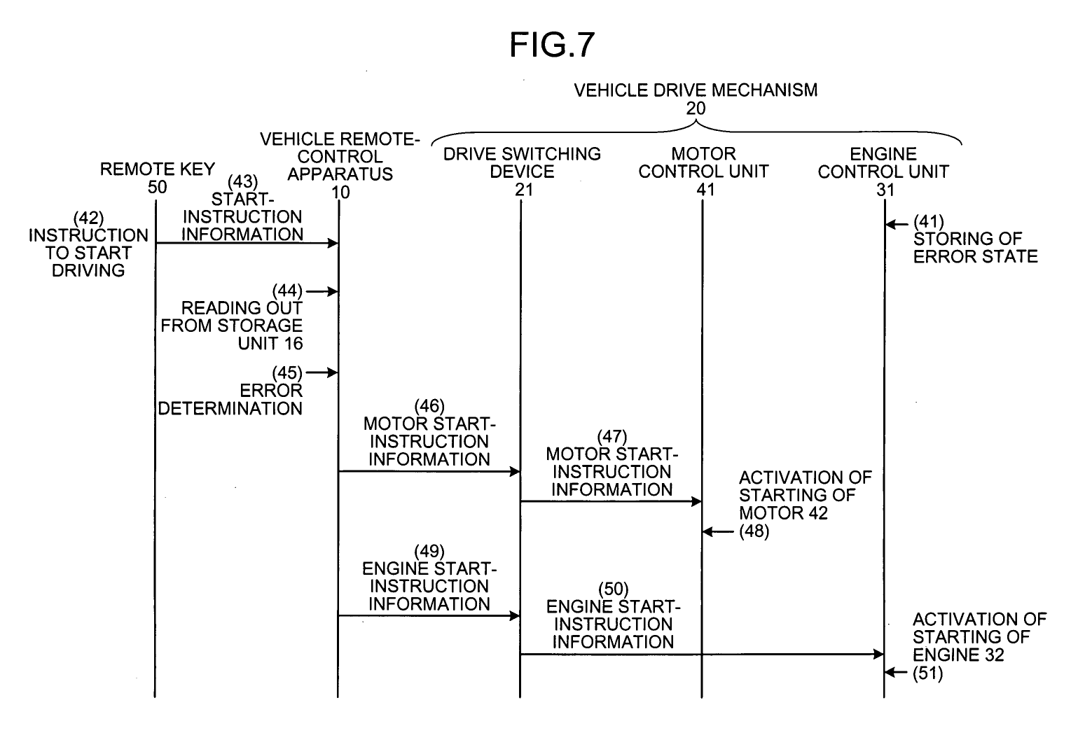

FIG. 7 is a flowchart of an operation procedure performed by the vehicle control system when performing the starting control of the motor and the engine based on information present in the storage. After the warming-up by the motor 42 and/or the engine 32 is finished, the storage unit 16 does not delete the information about the error in the motor 42 and the engine 32 present in the storage unit 16, and saves it (41).

The start-instruction information is sent from the remote key 50 (42), and the vehicle remote-control apparatus 10 receives the start-instruction information from the remote key 50 (43). The state determining unit 15 reads out information present in the storage unit 16 (a result of determination whether the state of the motor 42 is an abnormal state that is stored at the previous motor operation, and a result of determination whether the state of the engine 32 is an abnormal state that is stored at the previous engine operation) (44).

The state determining unit 15 determines at first whether the state of the motor 42 is an abnormal state based on information read out from the storage unit 16 (error determination). If the state of the motor 42 that is stored at the end of the previous operation of the motor is the abnormal state, the state determining unit 15 determines that the state of the motor 42 is the abnormal state. By contrast, if the state of the motor 42 that is stored at the end of the previous operation of the motor is the normal state, the state determining unit 15 determines that the state of the motor 42 is the normal state.

The state determining unit 15 then also determines whether the state of the engine 32 is an abnormal state based on information present in the storage unit 16 (error determination). If the state of the engine 32 that is stored at the end of the previous operation of the engine is the abnormal state, the state determining unit 15 determines that the state of the engine 32 is the abnormal state. By contrast, if the state of the engine 32 that is stored at the end of the previous operation of the engine is the normal state, the state determining unit 15 determines that the state of the engine 32 is the normal state (45).

If it is determined that the motor 42 and/or the engine 32 is in an abnormal state, the vehicle remote-control apparatus 10 instructs the motor 42 and/or the engine 32 determined as in the abnormal state not to perform the starting control, and instructs only the motor 42 and/or the engine 32 determined as in the normal state to perform the starting control (46).

In other words, if determining that the motor 42 is in the normal state, the state determining unit 15 instructs the switch instructing unit 17 to send the motor start-instruction information to the drive switching device 21 to start the motor 42 (46).

The drive switching device 21 sends the motor start-instruction information to the motor control unit 41 (47), and instructs the motor control unit 41 to start the motor 42. The motor 42 activates the starting (48), and the motor 42 performs the warming-up of the vehicle 5.

Furthermore, if determining that the engine 32 is in the normal state, the state determining unit 15 instructs the switch instructing unit 17 to send the engine start-instruction information to the drive switching device 21 to start the engine 32 (49).

The drive switching device 21 sends the engine start-instruction information to the engine control unit 31 (50), and instructs the engine control unit 31 to start the engine 32. The engine 32 activates the starting (51), and the engine 32 performs the warming-up of the vehicle 5.

Accordingly, the vehicle remote-control apparatus 10 can perform the warming-up easily and efficiently based on the information present in the storage unit 16 while reducing damage to the engine 32 and the motor 42.

After that, if the motor 42 and/or the engine 32 turns into an abnormal state, the motor control unit 41 and/or the, engine control unit 31 sends the motor error information and/or the engine error information to the vehicle remote-control apparatus 10. When receiving the motor error information and/or the engine error information, the state determining unit 15 determines that the motor 42 and/or the engine 32 is in an abnormal state, and causes the storage unit 16 to store therein a result of this determination.

On the other hand, if the motor 42 and/or the engine 32 turns into the normal state, the motor control unit 41 and/or the engine control unit 31 sends no motor error information or no engine error information to the vehicle remote-control apparatus 10.

When receiving no motor error information or no engine error information, the state determining unit 15 determines that the motor 42 and/or the engine 32 is in the normal state, and causes the storage unit 16 to store therein a result of this determination. As a result, the information indicating that the motor 42 and/or the engine 32 is in an abnormal state is deleted in the storage unit 16, and the storage unit 16 is reset.

The storage unit 16 can also be reset in accordance with instruction information from the remote key 50. In this case, the user inputs information for resetting the storage unit 16 into the remote key 50, the remote key 50 then sends the information for resetting the storage unit 16 to the vehicle remote-control apparatus 10. This enables the user to easily delete state information of the motor 42 or the engine 32 from the storage unit 16 as desired by the user.

Thus, the vehicle remote-control apparatus 10 performs the starting control of the engine 32 and the motor 42 based on the information present in the storage unit 16, so that the vehicle remote-control apparatus 10 can determines whether the motor 42 and the engine 32 are in an abnormal state without starting the motor 42 and the engine 32. Accordingly, the vehicle remote-control apparatus 10 can immediately determine an abnormal sate of the motor 42 and the engine 32, and instruct the motor 42 and/or the engine 32 to perform the warming-up, without damaging the engine 32 and/or the motor 42 in the abnormal state.

Driving of Engine and Motor in Accordance with Degree of Abnormal State

In addition, according to the present invention, if the engine 32 and/or the motor 42 is in an abnormal state, an operating state of the engine 32 and/or the motor 42 can also be controlled in accordance with a degree of the abnormal state of the engine 32 and/or the motor 42, instead of completely stopping the engine 32 and/or the motor 42 in the abnormal state. For example, if the temperature of the engine 32 (the motor 42) is between t1 degree and t2 degree, the engine is instructed to perform the warming-up with a half of the normal driving force. If the temperature of the engine 32 is between t2 degree and t3 degree, the engine is instructed to perform the warming-up with a third of the normal driving force. If the temperature of the engine 32 is at t3 degree or higher, the engine is instructed to stop.

This allows the engine 32 and the motor 42 to drive in accordance with the degree of the abnormal state of the engine 32 and the motor 42, thereby enabling the vehicle remote-control apparatus 10 to instruct the engine 32 and the motor 42 to drive efficiently while reducing damage to the engine 32 and the motor 42.

Selection of Motor Starting or Engine Starting by Remote Key

In the first embodiment, when the start-instruction information is sent from the remote key 50, the vehicle remote-control apparatus 10 starts the engine 32 after starting the motor 42. However, it can also be configured to instruct the vehicle remote-control apparatus 10 from the remote key 50 to perform the warming-up by one of the motor 42 and the engine 32, or both the motor 42 and the engine 32.

In this case, the user inputs one of the following information (selection information) into the remote key 50: instruction information for the motor 42 to perform the warming-up, instruction information for the engine 32 to perform the warming-up, and instruction information for both the motor 42 and the engine 32 to perform the warming-up. The vehicle remote-control apparatus 10 then selects the motor 42 and/or the engine 32 to perform the warming-up, and instructs the motor 42 and/or the engine 32 to perform the warming-up, based on selection information input into the remote key and sent to the vehicle remote-control apparatus 10.

Thus, the vehicle remote-control apparatus 10 can easily perform the warming-up by the motor 42 or the engine 32 as desired by the user with simple configuration. For example, in a zone where idling of a vehicle is prohibited, can instruct the vehicle drive mechanism 20 to control such that only the motor 42 performs the warming-up, while controlling the engine 32 not to start.

Determination of State Information Based on State of Sensor

In the first embodiment, performs the stopping control and the starting control of the motor 42 and the engine 32 based on an error state of the motor 42 and the engine 32. However, can also perform the stopping control and the starting control of the motor 42 and the engine 32 based on an error state of the temperature sensor 43, the temperature sensor 34, and the oil pressure sensor 33.

As a result, if the temperature sensor 43, the temperature sensor 34, or the oil pressure sensor 33 is in an abnormal state, the motor 42 and/or the engine 32 can be stopped, thereby avoiding that the states of the motor 42 and the engine 32 are determined by using the temperature sensor 43, the temperature sensor 34, or the oil pressure sensor 33 in the abnormal state. Thus, the vehicle remote-control apparatus 10 can instruct the engine 32 and the motor 42 to efficiently perform the warming-up while reducing damage to the engine 32 and the motor 42.

Further effects and variants can be easily led by one skilled in the art. Aspects of the present invention are not limited to specific embodiments as explained above. Therefore, various modifications can be achieved without departing from a scope of inventive concepts according to appended claims and equivalents.

### INDUSTRIAL APPLICABILITY

As described above, the starting control apparatus according to the present invention is suitable for starting control for a hybrid vehicle that includes a plurality of vehicle drive mechanisms.

1-12. (canceled)

13. A starting control apparatus that controls starting of a vehicle that includes a plurality of power units, the starting control apparatus comprising:
a state determining unit that determines whether each of the power units is in any one of a normal state and an abnormal state; and
a warming-up control unit that controls an abnormal power unit not to start and causes a normal power unit to start a power source and to carry out warming-up of the vehicle, the abnormal power unit being a power unit from among the power units determined as in the abnormal state by the state determining unit, and the normal power unit being a power unit from among the power units determined as in the normal state by the state determining unit.

14. The starting control apparatus according to claim 13, wherein the warming-up control unit stops the abnormal power unit during the warming-up of the vehicle.

15. The starting control apparatus according to claim 13, wherein
the warming-up control unit starts the power units when starting the warming-up of the vehicle, and
the state determining unit determines whether each of the power units that has been started is in any one of the normal state and the abnormal state.

16. The starting control apparatus according to claim 14, wherein
the warming-up control unit starts the power units when starting the warming-up of the vehicle, and
the state determining unit determines whether each of the power units that has been started is in any one of the normal state and the abnormal state.

17. The starting control apparatus according to claim 13, further comprising a storage unit that stores therein a result of determination of the state of the power units obtained by the state determining unit, wherein
when starting the warming-up of the vehicle, the state determining unit determines whether each of the power units is in any one of the normal state and the abnormal state based on the result of the determination of the state of the power units present in the storage unit.

18. The starting control apparatus according to claim 14, further comprising a storage unit that stores therein a result of determination of the state of the power units obtained by the state determining unit, wherein
when starting the warming-up of the vehicle, the state determining unit determines whether each of the power units is in any one of the normal state and the abnormal state based on the result of the determination of the state of the power units present in the storage unit.

19. The starting control apparatus according to claim 17, wherein if the state determining unit determines that at least one of the power units is in the abnormal state when starting the warming-up of the vehicle, the warming-up control unit performs starting control to none of the power units.

20. The starting control apparatus according to claim 18, wherein if the state determining unit determines that at least one of the power units is in the abnormal state when starting the warming-up of the vehicle, the warming-up control unit performs starting control to none of the power units.

21. The starting control apparatus according to claim 13, further comprising a remote control terminal that transmits a signal that includes information indicating which of the power units is to be used to perform the warming-up of the vehicle to the state determining unit, and
the state determining unit determines whether each of the power units is in any one of the normal state and the abnormal state based on the signal when starting the warming-up of the vehicle.

22. The starting control apparatus according to claim 14, further comprising a remote control terminal that transmits a signal that includes information indicating which of the power units is to be used to perform the warming-up of the vehicle to the state determining unit, and
the state determining unit determines whether each of the power units is in any one of the normal state and the abnormal state based on the signal when starting the warming-up of the vehicle.

23. The starting control apparatus according to claim 13, further comprising a detecting unit that detects whether each of the power units is in an abnormal state, wherein
the state determining unit determines whether each of the power units is in any one of the normal state and the abnormal state based on a result of detection of the state of the power units obtained by the detecting unit.

24. The starting control apparatus according to claim 13, further comprising:
a remote control terminal that transmits information for remote control of the vehicle; and
a warning unit that transmits warning information to the remote control terminal, if the state determining unit determines that at least one of the power units is in the abnormal state, the warning information indicating the abnormal state of the abnormal power unit.
